(19) United States
(12) Patent Application Publication
(10) Pub. No.: US 2024/0066402 A1
(43) Pub. Date: Feb. 29, 2024

(54) IMPLEMENTATION OF GAMING ASSETS AS NON-FUNGIBLE TOKENS (NFTS) ACROSS SAVE STATES OF GAMES

(71) Applicants: SONY GROUP CORPORATION, Tokyo (JP); SONY INTERACTIVE ENTERTAINEMENT LLC, San Mateo, CA (US)

(72) Inventors: JAMES R. MILNE, RAMONA, CA (US); TRUE XIONG, SAN DIEGO, CA (US); CHARLES MCCOY, SAN DIEGO, CA (US)

(21) Appl. No.: 17/893,990

(22) Filed: Aug. 23, 2022

(51) Int. Cl. A63F 13/493; G06F 16/27

(52) U.S. Cl. CPC A63F 13/493; G06F 16/27; A63F 2300/636

(57) ABSTRACT

An electronic device and method for implementation of gaming assets as non-fungible tokens (NFTs) across save states of games is disclosed. The electronic device may track a gaming asset associated with a player in a first gaming application. First information associated with a first game save state of the first gaming application and meta-data associated with the tracked gaming asset may be received. The electronic device may create a non-fungible token (NFT) associated with the tracked gaming asset based on the received meta-data. Second information associated with a second game save state of a second gaming application of a set of gaming applications may be received. The electronic device may retrieve the created NFT associated with the gaming asset from a distributed ledger. A restoration of the gaming asset may be initiated for the player in the second gaming application, based on the second information and the retrieved NFT.

This Application makes reference to United States Application Ser. No. (Attorney Docket No. SYP347705US02US), which was filed on Aug. 23, 2022. This Application also makes reference to United States Application Ser. No. (Attorney Docket No. SYP347705US03US), which was filed on Aug. 23, 2022. The above stated Patent Applications are hereby incorporated herein by reference in their entirety.

### FIELD

Various embodiments of the disclosure relate to non-fungible tokens (NFTs). More specifically, various embodiments of the disclosure relate to an electronic device and method for implementation of gaming assets as NFTs across save states of games.

### BACKGROUND

Advancements in gaming technology have led to an increase in development and use of gaming applications. Typically, a player may gain certain points and gifts such as, items, when the player plays a game. However, when the player wishes to use such points in another game or another mode of the same game, such points or items may not be available to the player in the other game or the other mode. The player may have to earn or buy the points or items again in the other game or the other mode to use such points or items, which may discourage the player from playing the other game or the other mode of the same game. For example, when a player plays a racing game in a first mode (e.g., a classic mode), the player may gain points or items such as, a new vehicle, a speed booster, customized vehicle accessories, and the like. However, after some time the player may switch to a second mode (e.g., a tournament mode) of the same racing game or another racing game. The player may not be able to use the points or items earned in the first mode and may have to replay the game in the second mode from a beginning level to earn the points or items, which may eventually hamper gaming experience and may discourage the player from playing such games.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for implementation of gaming assets as non-fungible token (NFTs) across save states of games is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for implementation of gaming assets as non-fungible tokens (NFTs) across save states of gaming applications, in accordance with an embodiment of the disclosure.

FIG. 2 is a block diagram that illustrates an exemplary electronic device of FIG. 1, in accordance with an embodiment of the disclosure.

FIG. 3 is a diagram that illustrates an exemplary processing pipeline for implementation of gaming assets as non-fungible tokens (NFTs) across save states of gaming applications, in accordance with an embodiment of the disclosure.

FIG. 4 is a diagram that illustrates an exemplary scenario for implementation of gaming assets as non-fungible tokens (NFTs) across save states of games of gaming applications, in accordance with an embodiment of the disclosure.

FIG. 5 is a flowchart that illustrates operations of an exemplary method for implementation of gaming assets as non-fungible tokens (NFTs) across save states of games of gaming applications, in accordance with an embodiment of the disclosure.

### DETAILED DESCRIPTION

The following described implementation may be found in the electronic device and method for implementation of gaming assets as non-fungible tokens (NFTs) across save states of games. Exemplary aspects of the disclosure may provide an electronic device that may implement gaming assets as non-fungible tokens (NFTs) across save states of games. The electronic device may track a gaming asset (e.g., a weapon, a gaming tool, or an avatar) associated with a player in a first gaming application (e.g., an athletic gaming application, a sports gaming application, or a fighting gaming application). The electronic device may receive first information associated with a first game save state (e.g., a first level, such as, a beginner level; and a mode, such as, a classic mode) of the first gaming application based on the tracked gaming asset. The electronic device may receive meta-data associated with the tracked gaming asset based on the received first information. Examples of the received meta-data of a gaming asset may include information, such as, but not limited to, properties of the gaming asset, a color of the gaming asset, a shape of the gaming asset, or powers related to the gaming asset. The electronic device may create a non-fungible token (NFT) associated with the tracked gaming asset based on the received meta-data. The NFT may be created based on a storage of the received meta-data to a distributed ledger associated with the first gaming application. The distributed ledger may be shared across a set of gaming applications including the first gaming application. The electronic device may further receive second information associated with a second game save state of a second gaming application of the set of gaming applications. The electronic device may retrieve the created NFT associated with the gaming asset from the distributed ledger. The electronic device may initiate a restoration of the gaming asset for the player in the second gaming application, based on the received second information and the retrieved NFT associated with the gaming asset.

Typically, the player may earn or buy certain points or items when the player plays a game. However, when the player wishes to use such points or items in another game or another session or mode of the same game, the earned or bought points or items may not be available to the player. Hence, the player may not be able to use such points or items. The player may have to earn or buy the points or items again in the other game or the other session or mode of the same game to use the points or items, which may discourage the player from playing games. The disclosed electronic device may create the NFTs for the gaming assets. The created NFTs of the present disclosure may enable the player to use the gaming assets (such as, points, powers, items, and the like) across different games or across different levels, sessions, and/or modes of the same game. The disclosed electronic device may ensure that the gaming asset associated with the created NFT may be used in only one game or one mode or level of the game, at an instance. The disclosed electronic device may allow the player that owns an NFT to use the NFT in any applicable game session. Thus, the overall gaming experience may be enhanced, and the player may be encouraged to play more games, based on usage of already earned or bought points or items in the other games or modes/levels of the same game.

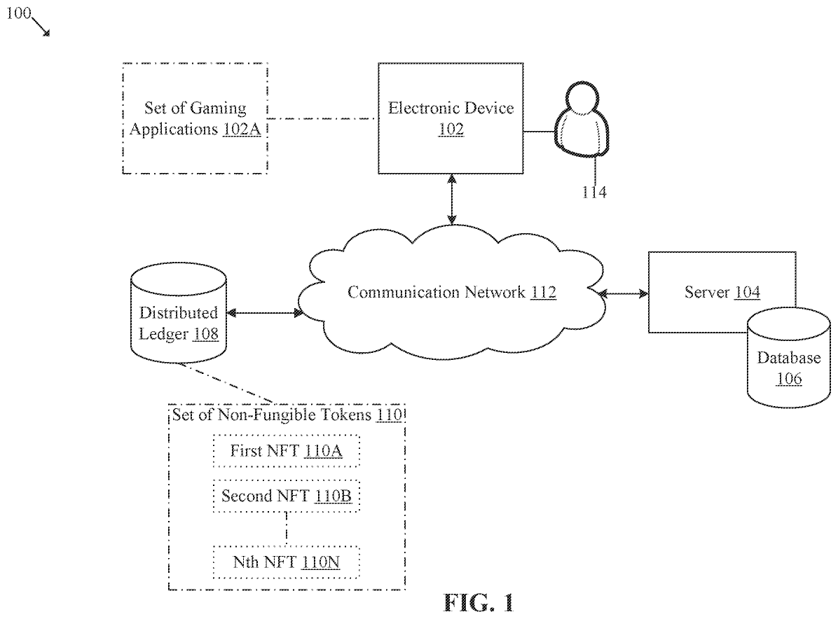

FIG. 1 is a block diagram that illustrates an exemplary network environment for implementation of gaming assets as non-fungible tokens (NFTs) across save states of gaming applications, in accordance with an embodiment of the disclosure. With reference to FIG. 1, there is shown a network environment 100. The network environment 100 may include an electronic device 102, a server 104, a database 106, a distributed ledger 108, and a communication network 112. The electronic device 102 may include a set of gaming applications 102A. The electronic device 102, the server 104, and the distributed ledger 108 may be communicatively coupled to one another, via the communication network 112. In FIG. 1, there is further shown a set of NFTs 110. The set of NFTs 110 may include ‘N’ number of NFTs such as, a first NFT 110A, a second NFT 110B, . . . and an Nth NFT 110N. In FIG. 1, there is further shown a user 114, who may be associated with or operate the electronic device 102. The N number of NFTs shown in FIG. 1 is presented merely as an example. The set of NFTs 110 may include only one NFT or more than N NFTs, without deviation from the scope of the disclosure. For the sake of brevity, only N NFTs have been shown in FIG. 1. However, in some embodiments, there may be more than N NFTs, without limitation of the scope of the disclosure.

The electronic device 102 may include suitable logic, circuitry, interfaces, and/or code that may be configured to track a gaming asset (e.g., a hat) associated with a player in a first gaming application of the set of gaming applications 102A. The electronic device 102 may be further configured to receive first information associated with a first game save state of the first gaming application based on the tracked gaming asset. The electronic device 102 may be further configured to receive meta-data associated with the tracked gaming asset based on the received first information. Based on the received meta-data associated with the tracked gaming asset, the electronic device 102 may create an NFT (e.g., the first NFT 110A) of the set of NFTs 110. The electronic device 102 may store first NFT 110A in the distributed ledger 108 and use the first NFT 110A to enable the tracked gaming asset in a second gaming application of the set of gaming applications 102A, at a certain second save state of the second gaming application. Examples of the electronic device 102 may include, but are not limited to, a computing device, a smartphone, a cellular phone, a mobile phone, a gaming device, a gaming console, a smart television (TV), an augmented reality (AR)/virtual reality (VR)/mixed reality (MR) device, a head-mounted display (HMD) for gaming, a heads-up display (HUD) for gaming, smart glasses for gaming, a mainframe machine, a server, a computer workstation, and/or a consumer electronic (CE) device.

The server 104 may include suitable logic, circuitry, and interfaces, and/or code that may be configured to create the non-fungible token (NFT) associated with the tracked gaming asset based on the received meta-data. The electronic device 102 may include suitable logic, circuitry, and interfaces, and/or code that may be configured to create the non-fungible token (NFT) associated with the tracked gaming asset. The NFT may be created based on a storage of the received meta-data to the distributed ledger 108 associated with the first gaming application. The distributed ledger 108 may be shared across the set of gaming applications 102A including the first gaming application. The server 104 may be further configured to receive second information associated with a second game save state of a second gaming application of the set of gaming applications 102A. The server 104 may be further configured to retrieve the created NFT associated with the gaming asset from the distributed ledger 108. The server 104 may be further configured to initiate a restoration of the gaming asset for the player in the second gaming application, based on the received second information and the retrieved NFT associated with the gaming asset. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102, as two separate entities. In certain embodiments, the functionalities of the server 104 can be incorporated in its entirety or at least partially in the electronic device 102 without a departure from the scope of the disclosure. In certain embodiments, the server 104 may host the database 106. Alternatively, the server 104 may be separate from the database 106 and may be communicatively coupled to the database 106.

The database 106 may include suitable logic, interfaces, and/or code that may be configured to store the set of gaming applications 102A (including, for example, the first gaming application and the second gaming application), the first game save state and the second game save state. The database 106 may be derived from data off a relational or non-relational database, or a set of comma-separated values (csv) files in conventional or big-data storage. The database 106 may be stored or cached on a device, such as a server (e.g., the server 104) or the electronic device 102. The device that stores the database 106 may be configured to receive a query for information related to the first gaming application, the second gaming application, the first game save state, or the second game save state. The device of the database 106 may be configured to retrieve and provide the queried information to the electronic device 102 (or the server 104) based on the received query.

In some embodiments, the database 106 may be hosted on a plurality of servers stored at same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The distributed ledger 108 may be a decentralized and distributed database system that may maintain an immutable record of data operations or transactions such as, the set of NFTs 110. A set of data operations may be grouped together as a block and may be further linked to a previous block of data operations to form a chain of a plurality of blocks. All blocks of data operations may be stored in a decentralized manner, whereby all participants or nodes store all the plurality of blocks. Further, the distributed ledger 108 may include an operating system which may allow for deployment of the group of smart contracts between multiple parties, for example, the user 114 and the electronic device 102. In some implementations, different nodes of the distributed ledger may be owned and/or operated by different entities, such as businesses or individuals. In some implementations, all of the nodes of the distributed ledger may be owned and/or operated by a single entity, such as a game publisher or game platform provider.

The distributed ledger 108 may be a chain of blocks which uses accounts as state objects and a state of each account can be tracked by the chain. The accounts represent identities of users, mining nodes, or automated agents. All the blocks of data operations or the smart contract are associated with the accounts on the chain of blocks. By way of example, and not limitation, the distributed ledger 108 may be an Ethereum blockchain which may use accounts as state objects and a state of each account can be tracked by the Ethereum blockchain. The accounts represent identities of users, mining nodes, or automated agents. All the blocks of data operations or the smart contract are associated with the accounts on the Ethereum Blockchain. The scope of the disclosure may not be limited to the implementation of the distributed ledger 108 as the Ethereum blockchain, a Hyperledger blockchain, or a Corda blockchain. Other implementations of the distributed ledger 108 may be possible in the present disclosure, without a deviation from the scope of the present disclosure.

The communication network 112 may include a communication medium through which the electronic device 102, the server 104, and the distributed ledger 108 may communicate with one another. The communication network 112 may be one of a wired connection or a wireless connection. Examples of the communication network 112 may include, but are not limited to, the Internet, a cloud network, Cellular or Wireless Mobile Network (such as, Long-Term Evolution and 5th Generation (5G) New Radio (NR)), a satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 112 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

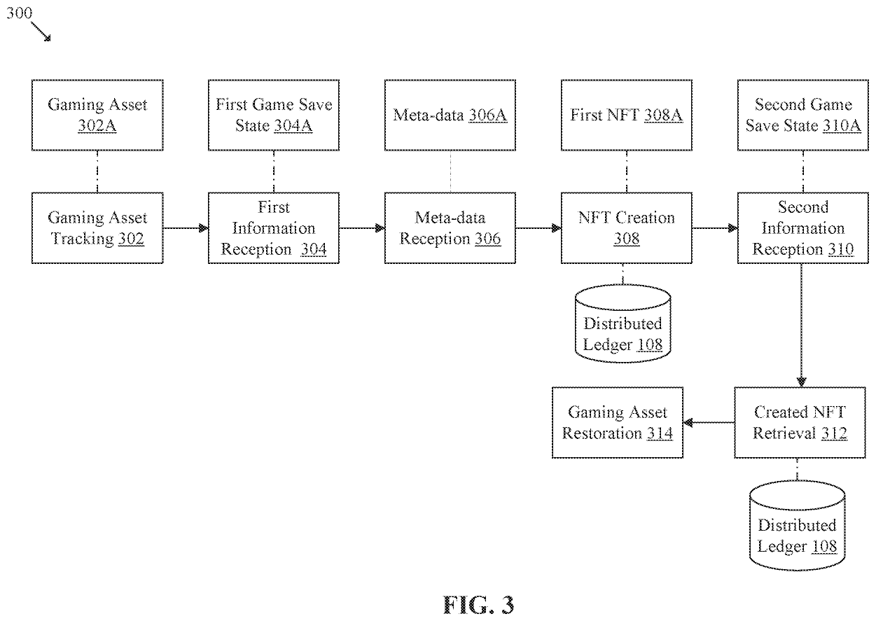

In operation, the electronic device 102 may be configured to track the gaming asset associated with the player in the first gaming application. It may be appreciated that the gaming asset may be tools to play the first gaming application effectively. For example, the first gaming application may be an application that may be used to play virtual games on electronic devices such as, a computer, a mobile phone, or a game console. For example, the first gaming application may be a shooting gaming application and the gaming asset may be an arrow for shooting. The gaming asset may be tracked in the first gaming application. Details related to the gaming asset are provided, for example, in FIG. 3.

The electronic device 102 may be configured to receive the first information associated with the first game save state of the first gaming application based on the tracked gaming asset. The first information may correspond to attributes associated with the first game save state of the first gaming application. In an example, the first gaming application may be the shooting gaming application and the first information may be a level of the shooting gaming application, a power of the arrow, points earned, number of birds shot, and the like. The first game save state may save a progress of the player in the shooting gaming application. Details related to the first information and the first game save state are provided, for example, in FIG. 3.

The electronic device 102 may be configured to receive meta-data associated with the tracked gaming asset based on the received first information. The meta-data may include attributes associated with the tracked gaming asset. In an example, the first gaming application may be an archery game and the meta-data may include a name of the tracked gaming asset such as, a fast arrow, and an attribute of the tracked gaming asset may be a poisonous head, and the like. Details related to the meta-data associated with the tracked gaming asset are further provided, for example, in FIG. 3.

The electronic device 102 may be configured to create the non-fungible token (NFT) associated with the tracked gaming asset based on the received meta-data. The NFT may be created based on the storage of the received meta-data to the distributed ledger 108 associated with the first gaming application. The distributed ledger 108 may be shared across the set of gaming applications 102A including the first gaming application. It may be appreciated that the NFT may be a non-interchangeable and non-fungible unit of data representative of a digital asset, that may be stored on the distributed ledger 108. For example, in order to create the NFT, the meta-data including attributes (such as, fast, and poisonous) of the gaming asset (e.g., an arrow) may be saved on the distributed ledger 108 such as, including one or more blockchain nodes. Details related to the creation of the NFT are provided, for example, in FIG. 3.

The electronic device 102 may be configured to receive the second information associated with the second game save state of the second gaming application of the set of gaming applications. The second information may include attributes associated with the second game save state of the second gaming application. For example, the second gaming application may a twentieth level of the shooting gaming application. The second information may be the level, that is, twenty. Details related to the second information and the second game save state are further provided, for example, in FIG. 3.

The electronic device 102 may be configured to retrieve the created NFT associated with the gaming asset from the distributed ledger 108. The gaming asset associated with the created NFT may need to be used in the second game save state of the second gaming application. In order to use the gaming asset in the second gaming application, the created NFT may be retrieved from the distributed ledger 108. Details related to the retrieval of the created NFT are further provided, for example, in FIG. 3.

The electronic device 102 may be configured to initiate the restoration of the gaming asset for the player in the second gaming application, based on the received second information and the retrieved NFT associated with the gaming asset. Once the created NFT is retrieved, the gaming asset associated with the retrieved NFT may be restored for the player in the second gaming application. For example, the NFT may be created for the arrow (i.e., gaming asset) and stored in the distributed ledger 108. In order to use the arrow in the second gaming application, the created NFT for the arrow may be retrieved from the distributed ledger 108. Further, the arrow may be restored in the second game save state so that the player may use the arrow in the second game save state. Details related to the restoration of the gaming asset for the player in the second gaming application are further provided, for example, in FIG. 3.

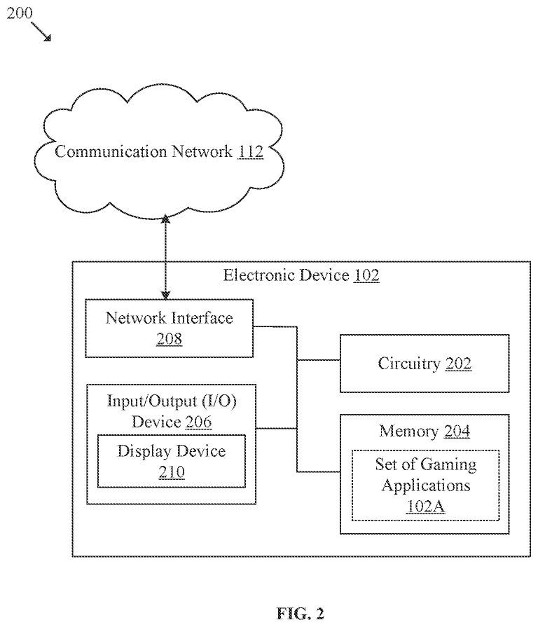

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown the exemplary electronic device 102. The electronic device 102 may include circuitry 202, a memory 204, an input/output (I/O) device 206, and a network interface 208. The memory 204 may include the set of gaming applications 102A, and the input/output (I/O) device 206 may include a display device 210. The network interface 208 may connect the electronic device 102 with the distributed ledger 108 and the server 104, via the communication network 112.

The circuitry 202 may include suitable logic, circuitry, and/or interfaces that may be configured to execute program instructions associated with different operations to be executed by the electronic device 102. The operations may include gaming asset tracking, first information reception, meta-data reception, NFT creation, second information reception, created NFT retrieval, and gaming asset restoration. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The one or more instructions stored in the memory 204 may be configured to execute the different operations of the circuitry 202 (and/or the electronic device 102). The memory 204 may be configured to store the set of gaming applications 102A. Further, the memory 204 may store the first gaming application, the second gaming application, the first game save state, and the second game save state. The memory 204 may further store the received meta-data, the first information, and the second information. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive a user input indicative of a selection of the gaming asset and the gaming application by the user 114. The I/O device 206 may be further configured to display the set of gaming applications 102A and the selected gaming asset. The I/O device 206 may include various input and output devices, which may be configured to communicate with the circuitry 202. The I/O device 206 may include the display device 210. Examples of the I/O device 206 may include, but are not limited to, a touch screen, the display device 210, a keyboard, a mouse, a joystick, a microphone, or a speaker. Examples of the I/O device 206 may further include braille I/O devices, such as, braille keyboards and braille readers.

The network interface 208 may include suitable logic, circuitry, interfaces, and/or code that may be configured to facilitate communication between the electronic device 102, the distributed ledger 108, and the server 104. The network interface 208 may be implemented by use of various known technologies to support wired or wireless communication of the electronic device 102 with the communication network. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The display device 210 may include suitable logic, circuitry, and interfaces that may be configured to display the set of gaming applications 102A, a set of gaming assets, the first gaming application, and the second gaming application. The display device 210 may be a touch screen which may enable a user (e.g., the user 114) to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display. Various operations of the circuitry 202 for implementation of gaming assets as NFTs across save states of gaming applications are described further, for example, in FIG. 3.

FIG. 3 is a diagram that illustrates an exemplary processing pipeline for implementation of gaming assets as non-fungible tokens (NFTs) across save states of gaming applications, in accordance with an embodiment of the disclosure. FIG. 3 is explained in conjunction with elements from FIG. 1 and FIG. 2. With reference to FIG. 3, there is shown an exemplary processing pipeline 300 that illustrates exemplary operations from 302 to 314 for implementation of gaming assets as NFTs. The exemplary operations 302 to 314 may be executed by any computing system, for example, by the electronic device 102 of FIG. 1 or by the circuitry 202 of FIG. 2. The exemplary processing pipeline 300 further illustrates a gaming asset 302A, a first game save state 304A, meta-data 306A, a first NFT 308A, a second game save state 310A, and the distributed ledger 108.

At 302, a gaming asset tracking operation may be executed. The circuitry 202 may be configured to track a gaming asset (e.g., the gaming asset 302A) associated with the player in the first gaming application. It may be appreciated the gaming asset 302A may correspond to tools to play the first gaming application effectively. The first gaming application may be applications that may be used to play virtual games on electronic devices such as, a computer, a mobile phone, a smart television (TV), a gaming console, smart glasses, or a virtual reality (VR)/augmented reality (AR) headset, and the like. The player such as, the user 114 of FIG. 1, may use the gaming asset 302A when the player plays the first gaming application. In an example, the first gaming application may be a football gaming application, and the gaming asset 302A may be a football, a certain type of shoes, a dress/jersey, an accessory of a footballer, and the like. In another example, the first gaming application may be a vehicle racing gaming application, and the gaming asset 302A may be a four-wheeler such as, a red car. In such case, a plurality of vehicles along with the red car may participate in a race. The player may use one or more controls to move the red car in the vehicle racing gaming application. The vehicle that reaches an end point first may be ranked with a first position. The plurality of vehicles along with the red car may be tracked throughout the race to determine insights such as, ranks, points, levels, powers earned, and the like, for the player. In another example, the first gaming application may correspond to a virtual fighting gaming application where two or more players may fight against each other and the player that defeats other players may be regarded as a winner. In such case, the gaming asset 302A may be a weapon used for fighting. The use of weapons may be tracked in such gaming application.

In an embodiment, the gaming asset may correspond to at least one of the weapon, a gun, an avatar, a costume, an accessory, a vehicle, a character, a prop, a player status, or a gaming tool. In case of a fighting gaming application, a weapon may be used by the players to fight against each other. Examples of the weapon may include, but are not limited to, a basic sword, a magic sword, an axe, a gun, a stick, a rope, a chain, and the like. The gun may be used in the first gaming applications such as, shooting games, mystery games, and the like. Examples of the gun may include, but is not limited to, a machine gun, an assault rifle, a shotgun, a snipper gun, and the like. The avatar may be a character that may represent the player in the first gaming application. For example, the first gaming application may be a running gaming application where the player may run along a track to earn points and gems. The avatar may be an icon or character that may represent the player that may run along the track. The costume may be an outfit that may be associated with the icon of the first gaming application. The use of costume may enrich player experience, provide certain powers associated with the costume, and the like. The accessory may be an extra item associated with the icon. For example, the accessory may be a hat that may be associated with the avatar. The vehicle may include two-wheeler vehicles or four-wheeler vehicles that may be used in the first gaming application. The character may be a person in the first gaming application. The prop may engage the player and may enrich gaming experience. The gaming tool may help the player to play the first gaming application. The gaming asset may change according to the first gaming application. For example, the gaming asset for a racing game may be the vehicle. Similarly, the gaming asset for the virtual fighting gaming application may be the weapon or the costume. In some implementations, the gaming asset may be customized by the player. For example, a player may specify aspects of the gaming asset such as size, shape, style, appearance, configurations, and attachments. In some implementations, the gaming asset may change as it is used in game play. For example, a player may upgrade the asset, use expendable units in the asset, reload expendable units in the asset, change attachments, or modify the appearance. A player status may include meta-data about the player, such as a membership card for a particular guild, associated with the player in a gaming application. For example, the player status may indicate that a player achieved a goal, unlocked a power or a gaming asset, or is a member of group. The player status may also include game state information, such as an indication that the player befriended or angered a particular non-player character (or computer controlled character) in the game.

At 304, a first information reception operation may be executed. The circuitry 202 may be configured to receive first information associated with a first game save state (e.g., the first game save state 304A) of the first gaming application based on the tracked gaming asset 302A. The first information may be meta-data associated with the first game save state 304A of the first gaming application. In an example, the first information may correspond to a level at which the player reaches when the player plays the first gaming application at a certain time instance. In another example, the first information may correspond to points or rewards earned by the player in the first gaming application at the particular time instance. In another example, the first information may correspond to the tracked gaming asset that may be earned or bought by the player when the player plays the first gaming application at the particular time instance. The first information may be determined when the player clears a level of the first gaming application, periodically after a predefined time interval of gameplay, or based on a user input of the player to save the game and create a save-point or checkpoint in the first gaming application. The first information, so determined, may correspond to the first game save state 304A of the first gaming application. Thus, the first game save state 304A may correspond to a status of game progress of the player in the first gaming application. The status of game progress may be determined at the end of each level of the first gaming application, periodically after the predetermined time interval of gameplay, or based on a user input of the player to save the game and further create a save-point or checkpoint of the game progress. In an embodiment, the first game save state 304A may correspond to at least one of the level of the first gaming application, a mode of the first gaming application, an environment of the first gaming application, or a type of the player in the first gaming application.

In an embodiment, the first game save state 304A may correspond to the level of the first gaming application. It may be appreciated that the first gaming application may include plurality of levels. For example, if the first gaming application is the fighting gaming application, then the first gaming application may include certain number of levels, such as, two hundred levels. The player may reach the next level based on a victory against system generated opponents in preceding levels. With each level, the system generated opponents may fight with the player with greater intensity. The player may play the first gaming application till, say the 100^{th} level, and may save the game as the first game save state 304A. In such case, the first game save state 304A may correspond to the level (i.e., the level 100) till which the game is saved.

In an embodiment, the first game save state 304A may correspond to the mode of the first gaming application. It may be appreciated that the first gaming application may include a plurality of modes such as, but not limited to, a Christmas mode, a spring mode, a dark mode, a tournament mode, a classic mode, and the like. The plurality of modes may provide enriched gaming experience to the player as the first gaming application may become monotonous if the same mode is played throughout. In an example, the first gaming application may be the vehicle racing gaming application and the plurality of modes may be the Christmas mode, the spring mode, and the classic mode. The player may play the vehicle racing gaming application in the Christmas mode and may save it so the player may continue playing from the saved state later on. In such case, the first game save state 304A may correspond to the Christmas mode. In an embodiment, the plurality of modes may indicate the difficulty level of the gaming application, like an easy mode, a medium mode, a high mode, or an expert mode.

In an embodiment, the first game save state 304A may correspond to the environment of the first gaming application, where the environment of the first gaming application may correspond to a background of the first gaming application. For example, the first gaming application may be the running gaming application and the environment, may be spring, sunny, cloudy, and the like. The player may select the sunny environment and may save progress as the first game save state 304A. In such case, the first game save state 304A may correspond to the sunny environment.

In an embodiment, the first game save state 304A may correspond to the type of the player in the first gaming application. It may be noted that the type of the player may vary from game to game. For example, the type of the player may be a computer, a person, an auto generated player, and the like. In multi-player games, the types of players may vary. In an example, the first gaming application may be a chess gaming application and the user 114 may play against the computer. In such case, the first game save state 304A may correspond to the computer player. However, in case the chess gaming application enables the user 114 to play against another human player, the type of player may be a human player and the first game save state 304A may correspond to the human player. Thus, in case of the chess gaming application, the first game save state 304A may correspond to a certain save point in a first chess game between a first human player and a second human player. The second game save state 310A may correspond to another save point in a second chess game between the same first human player and an automated player (or artificial intelligence (AI)-based player) controlled by the electronic device 102. Hence, in case of the chess gaming application, the first game save state 304A may correspond to a human v/s human player mode (i.e., a first type of players), while the second game save state 310A may correspond to a human v/s automated player mode (i.e., a second type of players)

At 306, a meta-data reception operation may be executed. The circuitry 202 may be configured to receive meta-data (e.g., the meta-data 306A) associated with the tracked gaming asset 302A based on the received first information. The meta-data 306A may provide details associated with the tracked gaming asset 302A. In an example, the first gaming application may be the football gaming application and the tracked gaming asset 302A may be the football. In such case, the meta-data 306A may provide properties of the tracked gaming asset 302A. The meta-data 306A may include, but not limited to, a name of the tracked gaming asset 302A, which is the football, a color of the tracked gaming asset 302A (e.g., white), and the like. In an embodiment, the reception of the meta-data may be triggered by the reception of the first information. For example, the first information may be determined when the player clears a level of the first gaming application, may be determined periodically after a predefined time interval of gameplay, or may be determined based on a user input of the player to save the game and create a save-point or checkpoint in the first gaming application. The first information, so determined, may correspond to the first game save state 304A of the first gaming application. The meta-data may be received based on the reception of the first information. For example, once the first information corresponding to the first game save state 304A is determined and received, the meta-data associated with the gaming assets in the first gaming application may be received. Such gaming assets may be tracked and determined as linked to the first game save state 304A.

At 308, an NFT creation operation may be executed. The circuitry 202 may be configured to create an NFT (e.g., the first NFT 308A) associated with the tracked gaming asset 302A based on the received meta-data 306A. The NFT (e.g., the first NFT 308A) may be created based on a storage of the received meta-data 306A to the distributed ledger 108 associated with the first gaming application. The distributed ledger 108 may be shared across the set of gaming applications 102A including the first gaming application. It may be appreciated that the NFT (e.g., the first NFT 308A) may be a non-interchangeable and non-fungible unit of data that may be stored on the distributed ledger 108. Examples of the data unit associated with NFTs may include, but are not limited to, photos, videos, audio files, documents, gaming assets, and other digital assets. The NFT may be traded and the owner of the NFT or the buyer of the NFT may have rights over the NFT. For example, if the tracked gaming asset 302A is a football and the meta-data 306A associated with the football includes a shape (such as, circular), a color (such as, white), and a name (such as, a football), then the circuitry 202 may store the aforesaid meta-data 306A of the football to the distributed ledger 108. The distributed ledger 108 may store a number of such NFTs that may be shared across the set of gaming applications 102A to deploy corresponding gaming assets across the different gaming applications.

In an embodiment, each NFT may correspond to a unique asset (e.g., the gaming asset 302A) for each player. Further, multiple players may own the particular asset (e.g., the gaming asset 302A), based on progress of the players in the game. In such case, each such asset of the players may be represented by unique NFTs. Thus, the same gaming asset may be owned by multiple players simultaneously, based on the possession of corresponding separate NFTs associated with the gaming asset by the players.

At 310, a second information reception operation may be executed. The circuitry 202 may be configured to receive second information associated with a second game save state (e.g., the second game save state 310A) of the second gaming application of the set of gaming applications 102A. The second information may include meta-data associated with the second game save state 310A of the second gaming application. In an example, the second information may correspond to the level of gameplay that the player reaches in the second gaming application at a certain time instance. In another example, the second information may correspond to points earned by the player in the second gaming application at a certain time instance. In yet another example, the second information may correspond to gaming assets earned or bought by the player when the player plays the second gaming application, at a certain time instance. It may be noted the player may often pause the second gaming application. For example, once the player reaches a tenth level in the second gaming application, the player may provide a user input to pause and save as the second game save state 310A in order to prevent loss of gameplay progress. The player may resume the second gaming application from the second game save state 310A later on and may continue from the tenth level of the second gaming application.

In an embodiment, the second game save state 310A may correspond to at least one of a level of the second gaming application, a mode of the second gaming application, an environment of the second gaming application, or a type of the player in the second gaming application. The details of the second game save state 310A may be same as the details of the first game save state 304A described, for example, at 304 in FIG. 3. Therefore, the description of the second game save state 310A is omitted from the disclosure for the sake of brevity.

In an embodiment, the first gaming application may be different from the second gaming application. It may be appreciated that same gaming asset may be used across multiple games. In an example, the set of gaming applications 102A may include, a fighting gaming application A, a fighting gaming application B, a fighting gaming application C, a soccer gaming application, a cricket gaming application, and the like. In one scenario, the first gaming application may be the fighting gaming application A and the second gaming application may be the fighting gaming application B, wherein both the first and the second gaming applications may enable the player to use a sword to fight against computer generated players.

In an embodiment, the first gaming application may be same as the second gaming application. For example, the first gaming application may correspond to a first level of a vehicle racing gaming application and the second gaming application may correspond to a second level of the vehicle racing gaming application. In another example, the first gaming application may correspond to a classic mode of the vehicle racing gaming application and the second gaming application may correspond to a tournament mode of the vehicle racing gaming application.

At 312, an operation to retrieve the created NFT may be executed. The circuitry 202 may be configured to retrieve the created NFT associated with the gaming asset from the distributed ledger 108. The distributed ledger 108 may store the plurality of NFTs. The circuitry 202 may retrieve the created NFT (e.g., the first NFT 308A) for use of the gaming asset (e.g., the gaming asset 302A associated with the retrieved NFT) in the second gaming application. The circuitry 202 may request the distributed ledger 108 for the created first NFT 308A. The distributed ledger 108 may verify whether the request of the circuitry 202 is legitimate or not, and may further transmit the created first NFT 308A based on the verification.

At 314, an operation to restore the gaming asset 302A may be executed. The circuitry 202 may be configured to initiate a restoration of the gaming asset 302A for the player in the second gaming application, based on the received second information and the retrieved NFT associated with the gaming asset 302A. Once the created NFT is retrieved, the gaming asset 302A associated with the retrieved NFT (e.g., the first NFT 308A) may be restored for the player in the second gaming application. For example, the first NFT 308A may be associated with the gaming asset 302A, such as, the sword. Once the first NFT 308A is retrieved from the distributed ledger 108, the gaming asset 302A, such as, the sword, may be restored in the second gaming application for the player to play the second gaming application. Thus, the sword (i.e., gaming asset 302A), which may be used at the first game save state 304A in the first gaming application, may be available to the player and equipped at the second game save state 310A in the second gaming application. Hence, gaming assets may be shared across save points and among multiple gaming applications. The player may not be required to earn or buy the sword again in the second gaming application or in a new level/mode of the first gaming application, which may thereby enrich the gaming experience of the player.

In an embodiment, the circuitry 202 may be further configured to dis-associate the gaming asset 302A from the first game save state 304A of the first gaming application. The circuitry 202 may be further configured to associate the gaming asset 302A with the second game save state 310A of the second gaming application. It may be noted that the first NFT 308A created for the tracked gaming asset 302A (such as, a hat) may be used in more than one gaming applications. However, the electronic device 102 may enforce a rule that the gaming asset 302A associated with the created NFT may be used in only one gaming application at a time. Thus, in order to use the gaming asset 302A corresponding to the first game save state 304A of the first gaming application in the second game save state 310A of the second gaming application, the gaming asset 302A may be first dis-associated from the first game save state 304A. For example, the first gaming application may the fighting gaming application A and the second gaming application may the fighting gaming application B. The gaming asset 302A from the first game save state 304A of the fighting gaming application A may be the sword. The player may wish to use the sword in the fighting gaming application B. The sword may be dis-associated from the first game save state 304A of the fighting gaming application A and further the sword may be associated with the second game save state 310A of the fighting gaming application B. Once the sword is associated with the second game save state 310A of the fighting gaming application B, the sword may be available for use at the second game save state 310A of the fighting gaming application B.

In an embodiment, the gaming asset 302A may be unequipped for the player in the first gaming application, based on the dis-association of the gaming asset 302A from the first game save state 304A. Further, the gaming asset 302A may be equipped for the player in the second gaming application, based on the association of the gaming asset with the second game save state 310A. In order to use the tracked gaming asset 302A in the second gaming application, the tracked gaming asset 302A may be removed or unequipped from the first game save state 304A. In an example, the first gaming application may the first level of the racing gaming application and the second gaming application may the second level of the same racing gaming application. The gaming asset 302A from the first game save state 304A of the first level of the racing gaming application may be a speed board that may enhance the speed of the player. The player may wish to use the same speed board in the second level of the racing gaming application. In such case, the speed board may be dis-associated from the first game save state 304A of the first level of the racing gaming application. The dis-association of the speed board from the first game save state 304A of the first level of the racing gaming application may enable the speed board to be unequipped from the avatar that represents the player in the first level. Further, the speed board may be associated with the second game save state 310A of the second level of the racing gaming application. The association of the speed board (i.e., gaming asset 302A) with the second game save state 310A of the second level of the racing gaming application may enable the avatar that represents the player to use the speed board to run faster. In another example, the tracked gaming asset 302A may be a cap that may be associated with the avatar in the first game save state 304A of the first gaming application. The player may want to use the cap in the second game save state 310A. The cap may be dis-associated from the first game save state 304A and the cap may be further unequipped from the avatar in the first game save state 304A. Thereafter, the cap may be associated with the second game save state 310A and the cap may be further equipped to the avatar in the second game save state 310A. Thus, the gaming asset 302A may be used in only one gaming application at one time. In an embodiment, a game asset may indicate the ownership of an asset by a player such that a gaming application will allow the player to use the gaming asset in a game state without disassociating it from other game states where it is used. For example, a player may have an NFT that indicates that they have a membership in a guild, and the game may allow them to use that NFT in multiple game states simultaneously, which may include game states that are newly created by the player and/or game states the player created before obtaining the NFT.

Typically, the player may earn or buy certain points or items when the player (e.g., the user 114) plays a game (e.g., the first gaming application). However, when the player wishes to use such points or items in another game (e.g., the second gaming application) or another mode of the same game, the earned or bought points or items may not be available to the player. Hence, the player may not be able to use such points or items. The player may have to earn or buy the points or items again in the other game or the other mode of the same game to use the points or items, which may discourage the player from playing games. The disclosed electronic device 102 may create the NFTs for the gaming assets. The created NFTs of the present disclosure may enable the player to use the gaming assets (such as, points, powers, items, and the like) across different games or across different levels and/or modes of the same game. The disclosed electronic device 102 may ensure that the gaming asset associated with the created NFT may be used in only one game or one mode or level of the game, at an instance. Thus, the overall gaming experience may be enhanced, and the player may be encouraged to play more games, based on usage of already earned or bought points or items in the other games or modes/levels of the same game.

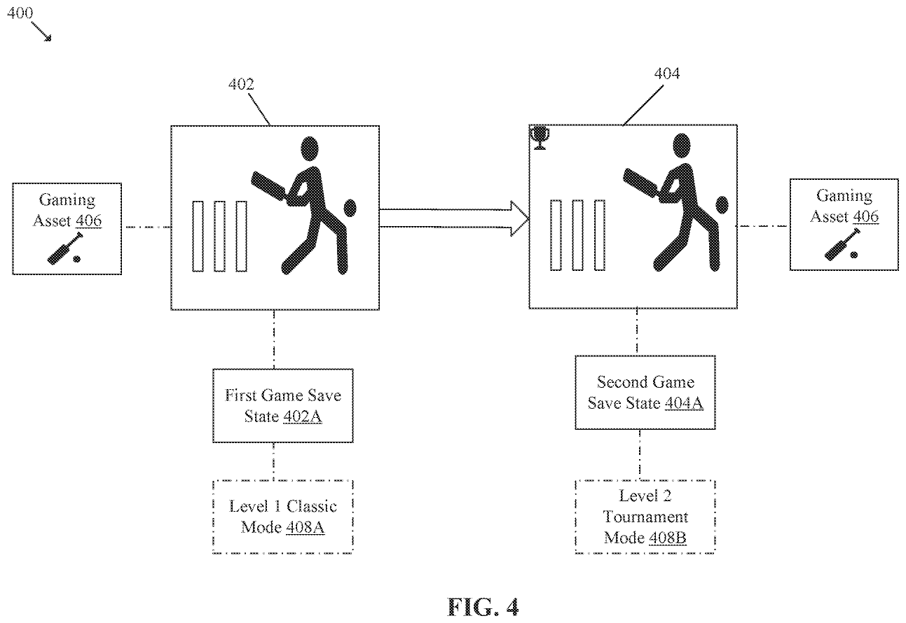

FIG. 4 is a diagram that illustrates an exemplary scenario for implementation of gaming assets as non-fungible tokens (NFTs) across save states of gaming applications, in accordance with an embodiment of the disclosure. FIG. 4 is described in conjunction with elements from FIG. 1, FIG. 2, and FIG. 3. With reference to FIG. 4, there is shown an exemplary scenario 400. The scenario 400 may include a first gaming application 402 and a second gaming application 404 that may be displayed on the display device 210 associated of the electronic device 102. The scenario 400 may further include a gaming asset 406 that may be associated with both the first gaming application 402 and the second gaming application 404. The scenario 400 may further include a first game save state 402A, which may be a level 1 classic mode 408A of the first gaming application 402, and a second game save state 404A, which may be a level 2 tournament mode 408B of the second gaming application 404. A set of operations associated the scenario 400 is described herein.

In the scenario 400 of FIG. 4, the first gaming application 402 and the second gaming application 404 may correspond to different modes and/or different levels of the same gaming application, such as, a cricket gaming application. However, the scope of the disclosure may not be limited to the first gaming application 402 and the second gaming application 404 as the same gaming application. In certain scenarios, the first gaming application 402 and the second gaming application 404 may correspond to different games, without a deviation from the scope of the disclosure.

The circuitry 202 may be configured to track the gaming asset 406 associated with the player in the first gaming application 402. In such case, the mode or level of the first gaming application 402 may correspond to the level 1 classic mode 408A of the cricket gaming application. The gaming asset 406 may be a bat (or a ball) that may be tracked. The circuitry 202 may be configured to receive the first information associated with the first game save state 402A of the first gaming application 402 based on the tracked gaming asset 406. With reference to FIG. 4, the first game save state 402A may correspond to the level of the first gaming application 402, which may be “level 1”, and the mode of the first gaming application 402, which may be “classic mode”. Thus, the level 1 classic mode 408A may correspond to the first game save state 402A. The circuitry 202 may be further configured to receive meta-data associated with the tracked gaming asset 406 based on the received first information. With reference to FIG. 4, the meta-data may correspond to, but is not limited to, the name of the tracked gaming asset 406, which may be the bat, and the color of the tracked gaming asset 406, which may be white. The circuitry 202 may be further configured to create the NFT associated with the bat based on the received meta-data. The received meta-data may be stored on the distributed ledger (such as, the distributed ledger 108 of FIG. 1) to create the NFT for the bat. The distributed ledger (such as, the distributed ledger 108 of FIG. 1) may be shared across the set of gaming applications 102A including, for example, various modes and levels of the cricket gaming application.

The circuitry 202 may be further configured to receive second information associated with the second game save state 404A of the second gaming application 404 of the set of gaming applications. The second information may include attributes associated with the second game save state 404A of the second gaming application 404. The second game save state 404A may correspond to a certain level (such as, “level 2”) and a certain mode (e.g., “tournament mode”) of the second gaming application 404. For example, with reference to FIG. 4, the second game save state 404A may correspond to the level 2 tournament mode 408B of the second gaming application 404 (e.g., the cricket gaming application).

The circuitry 202 may be further configured to retrieve the created NFT associated with the gaming asset 406 from the distributed ledger (such as, the distributed ledger 108 of FIG. 1). With reference to FIG. 4, the created NFT for the bat may be retrieved from the distributed ledger (such as, the distributed ledger 108 of FIG. 1). The circuitry 202 may be further configured to initiate the restoration of the gaming asset 406 for the player in the second gaming application 404, based on the received second information and the retrieved NFT associated with the gaming asset 406. Thus, the gaming asset 406, i.e., the bat, may be restored in the level 2 tournament mode 408B. The circuitry 202 may dis-associate the bat from the first game save state 402A of the first gaming application 402. Further, the bat may be unequipped for the player in the level 1 classic mode 408A of the cricket gaming application based on the dis-association of the bat from the first game save state 402A. Thus, the player in the level 1 classic mode 408A of the cricket gaming application may no longer be able to use the bat. Further, the circuitry 202 may associate the bat with the second game save state 404A of the second gaming application 404. Further, the bat may be equipped for the player in the level 2 tournament mode 408B of the cricket gaming application based on the association of the bat the second game save state 404A. Thus, at a time, only one gaming application may use the gaming asset 406.

It should be noted that the scenario 400 of FIG. 4 is for exemplary purposes and should not be construed to limit the scope of the disclosure.

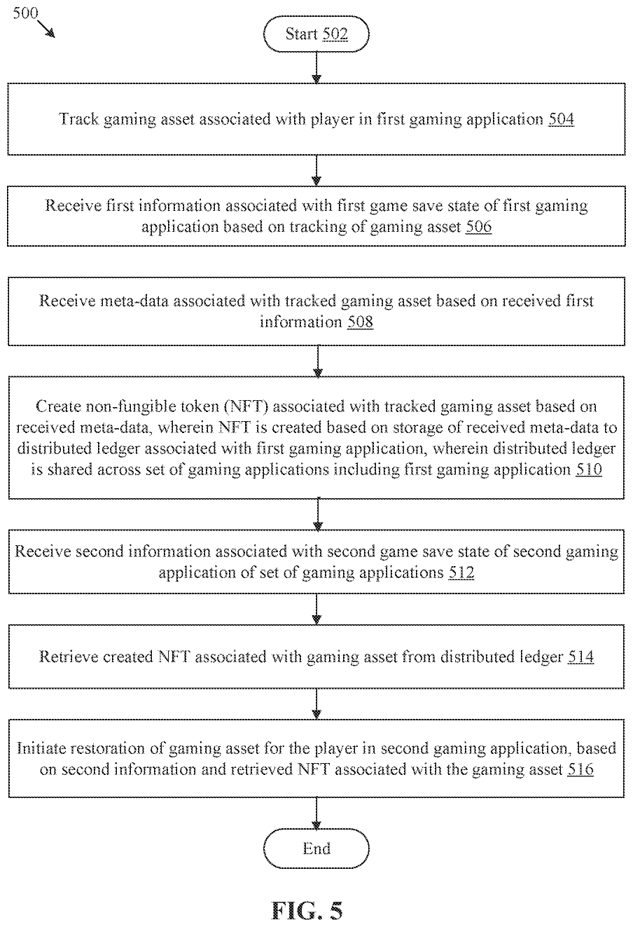

FIG. 5 is a flowchart that illustrates operations of an exemplary method for implementation of gaming assets as non-fungible tokens (NFTs) across save states of gaming applications, in accordance with an embodiment of the disclosure. FIG. 5 is described in conjunction with elements from FIG. 1, FIG. 2, FIG. 3, and FIG. 4. With reference to FIG. 5, there is shown a flowchart 500. The flowchart 500 may include operations from 502 to 516 and may be implemented by the electronic device 102 of FIG. 1 or by the circuitry 202 of FIG. 2. The flowchart 500 may start at 502 and proceed to 504.

At 504, the gaming asset associated with the player in the first gaming application may be tracked. The circuitry 202 may be configured to track the gaming asset associated with the player in the first gaming application. In an embodiment, the gaming asset (e.g., the gaming asset 406) may be the tool to play the first gaming application (e.g., the first gaming application 402) effectively. In an embodiment, the gaming asset (e.g., the gaming asset 406) may correspond to at least one of the weapon, the gun, the avatar, the costume, the accessory, the vehicle, the character, the prop, or the gaming tool. In an example, the first gaming application may be a fighting gaming application and the gaming asset (e.g., the gaming asset 302A) may be the sword. In case of the fighting gaming application, the player may move the sword virtually to defeat the opponents. The possession of the sword by the player may be tracked in the fighting gaming application. Details related to the tracked gaming asset are provided, for example, in FIG. 3 (at 302).

At 506, the first information associated with the first game save state of the first gaming application may be received based on the tracked gaming asset. The circuitry 202 may be configured to receive the first information associated with the first game save state of the first gaming application based on the tracked gaming asset. In an embodiment, the first information may include attributes associated with the first game save state (e.g., the first game save state 402A) of the first gaming application (e.g., the first gaming application 402). For example, the first information may correspond to the level and/or the mode of the first gaming application in the first game save state 304A. In an embodiment, the first game save state (e.g., the first game save state 402A) may correspond to at least one of the level of the first gaming application (e.g., the first gaming application 402), the mode of the first gaming application, the environment of the first gaming application, and the type of the player in the first gaming application. For example, in case the first gaming application a soccer gaming application, then the first game save sate may correspond to, for example, a level 1 of the soccer gaming application. In an embodiment, the first information may be determined when the player clears a level of the first gaming application, periodically after a predefined time interval of gameplay, or based on a user input of the player to save the game and create a save-point or checkpoint in the first gaming application. The first information, so determined, may correspond to the first game save state 304A of the first gaming application. Details related to the first game save state are provided, for example, in FIG. 3 (at 304).

At 508, the meta-data associated with the tracked gaming asset (e.g., the tracked gaming asset 302A) may be received based on the received first information. The circuitry 202 may be configured to receive the meta-data associated with the tracked gaming asset (e.g., the tracked gaming asset 302A) based on the received first information. The meta-data may include details associated with the tracked gaming asset (e.g., the tracked gaming asset 302A). In an example, the first gaming application may be a racing gaming application and the tracked gaming asset may be a first car. In such case, the meta-data may provide properties of the tracked gaming asset, such as, a name (e.g., the first car) of the tracked gaming asset, the color (e.g., red) of the tracked gaming asset, accessories (e.g., speed booster) of the tracked gaming asset, and the like. In an embodiment, the reception of the meta-data may be triggered by the reception of the first information. The meta-data may be received based on to the reception of the first information. For example, once the first information corresponding to the first game save state 304A is determined and received, the meta-data associated with the gaming assets in the first gaming application, which may be tracked and determined as linked to the first game save state 304A, may be received. Details related to the meta-data associated with the tracked gaming asset are provided, for example, in FIG. 3 (at 306).

At 510, the non-fungible token (NFT) associated with the tracked gaming asset may be created based on the received meta-data, wherein the NFT (e.g., the first NFT 308A) is created based on the storage of the received meta-data to the distributed ledger (e.g., the distributed ledger 108) associated with the first gaming application (e.g., the first gaming application 402), and the distributed ledger (e.g., the distributed ledger 108) may be shared across the set of gaming applications (e.g., the set of gaming applications 102A) including the first gaming application (e.g., the first gaming application 402). The circuitry 202 may be configured to create the NFT (e.g., the first NFT 308A) associated with the tracked gaming asset based on the received meta-data. Details related to the creation of the non-fungible token (NFT) associated with the tracked gaming asset are provided, for example, in FIG. 3 (at 308).

At 512, the second information associated with the second game save state of the second gaming application of the set of gaming applications may be received. The circuitry 202 may be configured to receive second information associated with the second game save state of a second gaming application of the set of gaming applications. Similar to the first information, the second information may correspond to the meta-data associated with the second game save state (e.g., the second game save state 404A) of the second gaming application (e.g., the second gaming application 404). In an embodiment, the second game save state (e.g., the second game save state 404A) may correspond to at least one of the level of the second gaming application (e.g., the second gaming application 404), the mode of the second gaming application, the environment of the second gaming application, and the type of the player in the second gaming application. For example, if the second gaming application is a level 5 tournament mode of the chess gaming application, then the second information may include the level, which is the level 5, and/or the mode, which is the tournament mode. In such case, the second save state may be the level 5 and/or the tournament mode. Details related to the second game information and the second game save state of the second gaming application are provided, for example, in FIG. 3 (at 310).

At 514, the created NFT associated with the gaming asset may be retrieved from the distributed ledger 108. The circuitry 202 may be configured to retrieve the created NFT associated with the gaming asset from the distributed ledger 108. In an embodiment, the distributed ledger 108 may include the plurality of NFTs. The created NFT (e.g., the created first NFT 308A) may be retrieved in order to deploy and use the gaming asset associated with the created NFT in the second gaming application (e.g., the second gaming application 404) at the second game save state. Details related to the retrieval of the created NFT associated with the gaming asset are provided, for example, in FIG. 3 (at 312).

At 516, the restoration of the gaming asset for the player in the second gaming application may be initiated based on the received second information and the retrieved NFT associated with the gaming asset. The circuitry 202 may be configured to initiate the restoration of the gaming asset (e.g., the gaming asset 406) for the player in the second gaming application (e.g., the second gaming application 404), based on the received second information and the retrieved NFT associated with the gaming asset (e.g., the gaming asset 406). Once, the created NFT is retrieved, the gaming asset (e.g., the gaming asset 406) may be restored in the second gaming application (e.g., the second gaming application 404) for use by the player of the second gaming application (e.g., the second gaming application 404). For example, if the created NFT is for the gaming asset such as, a tennis ball, then the tennis ball may be restored in the second gaming application (e.g., a tennis game) at the second game save state, such as, a tenth level of the second gaming application (e.g., the tennis game). Details related to the restoration of the gaming asset are provided, for example, in FIG. 3 (at 314) and FIG. 4. Control may pass to end.

Although the flowchart 500 is illustrated as discrete operations, such as, 504, 506, 508, 510, 512, 514, and 516 the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102). Such instructions may cause the electronic device 102 to perform operations that may include tracking of a gaming asset associated with a player in a first gaming application. The operations may further include reception of first information associated with a first game save state of the first gaming application based on the tracked gaming asset. The operations may further include reception of meta-data associated with the tracked gaming asset based on the received first information. The operations may further include creation of a non-fungible token (NFT) associated with the tracked gaming asset based on the received meta-data. The NFT may be created based on a storage of the received meta-data to a distributed ledger (e.g., the distributed ledger 108) associated with the first gaming application. Further, the distributed ledger 108 may be shared across a set of gaming applications including the first gaming application. The operations may further include reception of second information associated with a second game save state of a second gaming application of the set of gaming applications. The operations may further include retrieval of the created NFT associated with the gaming asset from the distributed ledger 108. The operations may further include initiation of a restoration of the gaming asset for the player in the second gaming application, based on the received second information and the retrieved NFT associated with the gaming asset.

Exemplary aspects of the disclosure may provide an electronic device (such as, the electronic device 102 of FIG. 1) that includes circuitry (such as, the circuitry 202). The circuitry 202 may be configured to track a gaming asset (such as, the gaming asset 406 of FIG. 4) associated with a player in a first gaming application (such as, the first gaming application 402 of FIG. 4). The circuitry 202 may be configured to receive first information associated with a first game save state (such as, the first game save state 402A of FIG. 4) of the first gaming application (such as, the first gaming application 402 of FIG. 4) based on the tracked gaming asset (such as, the tracked gaming asset 406 of FIG. 4). The circuitry 202 may be configured to receive meta-data associated with the tracked gaming asset (such as, the tracked gaming asset 406 of FIG. 4) based on the received first information. The circuitry 202 may be configured to create a non-fungible token (NFT) (such as, the first NFT 308A of FIG. 3) associated with the tracked gaming asset (such as, the tracked gaming asset 406 of FIG. 4) based on the received meta-data. The NFT may be created based on a storage of the received meta-data to a distributed ledger (such as, distributed ledger 108 of FIG. 1) the associated with the first gaming application (such as, the first gaming application 402 of FIG. 4). The distributed ledger (such as, distributed ledger 108 of FIG. 1) may be shared across a set of gaming applications (such as, the set of gaming applications 102A of FIG. 1) including the first gaming application (such as, the first gaming application 402 of FIG. 4). The circuitry 202 may be configured to receive second information associated with a second game save state (such as, the second game save state 404A of FIG. 4) of a second gaming application (such as, the second gaming application 404 of FIG. 4) of the set of gaming applications (such as, the set of gaming applications 102A of FIG. 1). The circuitry 202 may be configured to retrieve the created NFT (such as, the created first NFT 308A of FIG. 3) associated with the gaming asset (such as, the gaming asset 406 of FIG. 4) from the distributed ledger (such as, distributed ledger 108 of FIG. 1). The circuitry 202 may be configured to initiate a restoration of the gaming asset (such as, the gaming asset 406 of FIG. 4) for the player in the second gaming application (such as, the second gaming application 404 of FIG. 4), based on the received second information and the retrieved NFT associated with the gaming asset (such as, the gaming asset 406 of FIG. 4).

In an embodiment, the first gaming application may be different from the second gaming application. In an embodiment, the first gaming application may be same as the second gaming application.

In an embodiment, the circuitry 202 may be further configured to dis-associate the gaming asset from the first game save state of the first gaming application. The circuitry 202 may be further configured to associate the gaming asset with the second game save state of the second gaming application. In an embodiment, the gaming asset may be unequipped for the player in the first gaming application, based on the dis-association of the gaming asset from the first game save state. Further, the gaming asset may be equipped for the player in the second gaming application, based on the association of the gaming asset with the second game save state.

In an embodiment, the first game save state may correspond to at least one of a level of the first gaming application, a mode of the first gaming application, an environment of the first gaming application, and a type of the player in the first gaming application. In an embodiment, the gaming asset may correspond to at least one of a weapon, a gun, an avatar, a costume, an accessory, a vehicle, a character, a prop, or a gaming tool.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
track a gaming asset associated with a player in a first gaming application;
receive first information associated with a first game save state of the first gaming application based on the tracked gaming asset;
receive meta-data associated with the tracked gaming asset based on the received first information;
create a non-fungible token (NFT) associated with the tracked gaming asset based on the received meta-data, wherein
the NFT is created based on a storage of the received meta-data to a distributed ledger associated with the first gaming application, and
the distributed ledger is shared across a set of gaming applications including the first gaming application;
receive second information associated with a second game save state of a second gaming application of the set of gaming applications;
retrieve the created NFT associated with the gaming asset from the distributed ledger; and
initiate a restoration of the gaming asset for the player in the second gaming application, based on the received second information and the retrieved NFT associated with the gaming asset.

2. The electronic device according to claim 1, wherein the first gaming application is different from the second gaming application.

3. The electronic device according to claim 1, wherein the first gaming application is same as the second gaming application.

4. The electronic device according to claim 1, wherein the circuitry is further configured to:
dis-associate the gaming asset from the first game save state of the first gaming application; and
associate the gaming asset with the second game save state of the second gaming application.

5. The electronic device according to claim 4, wherein
the gaming asset is unequipped for the player in the first gaming application, based on the dis-association of the gaming asset from the first game save state, and
the gaming asset is equipped for the player in the second gaming application, based on the association of the gaming asset with the second game save state.

6. The electronic device according to claim 1, wherein the first game save state corresponds to at least one of a level of the first gaming application, a mode of the first gaming application, an environment of the first gaming application, and a type of the player in the first gaming application.

7. The electronic device according to claim 1, wherein the gaming asset corresponds to at least one of a weapon, a gun, an avatar, a costume, an accessory, a vehicle, a character, a prop, a player status, or a gaming tool.

8. A method, comprising:
in an electronic device:
tracking a gaming asset associated with a player in a first gaming application;
receiving first information associated with a first game save state of the first gaming application based on the tracked gaming asset;
receiving meta-data associated with the tracked gaming asset based on the received first information;
creating a non-fungible token (NFT) associated with the tracked gaming asset based on the received meta-data, wherein
the NFT is created based on a storage of the received meta-data to a distributed ledger associated with the first gaming application, and
the distributed ledger is shared across a set of gaming applications including the first gaming application;
receiving second information associated with a second game save state of a second gaming application of the set of gaming applications;
retrieving the created NFT associated with the gaming asset from the distributed ledger; and
initiating a restoration of the gaming asset for the player in the second gaming application, based on the received second information and the retrieved NFT associated with the gaming asset.

9. The method according to claim 8, wherein the first gaming application is different from the second gaming application.

10. The method according to claim 8, wherein the first gaming application is same as the second gaming application.

11. The method according to claim 8, further comprising:
dis-associating the gaming asset from the first game save state of the first gaming application; and
associating the gaming asset with the second game save state of the second gaming application.

12. The method according to claim 11, wherein
the gaming asset is unequipped for the player in the first gaming application, based on the dis-association of the gaming asset from the first game save state, and
the gaming asset is equipped for the player in the second gaming application, based on the association of the gaming asset with the second game save state.

13. The method according to claim 8, wherein the first game save state corresponds to at least one of a level of the first gaming application, a mode of the first gaming application, an environment of the first gaming application, or a type of the player in the first gaming application.

14. The method according to claim 8, wherein the gaming asset corresponds to at least one of a weapon, a gun, an avatar, a costume, an accessory, a vehicle, a character, a prop, a player status, or a gaming tool.

15. A non-transitory computer-readable medium having stored thereon, computer-executable instructions that when executed by an electronic device, causes the electronic device to execute operations, the operations comprising:
tracking a gaming asset associated with a player in a first gaming application;
receiving first information associated with a first game save state of the first gaming application based on the tracked gaming asset;
receiving meta-data associated with the tracked gaming asset based on the received first information;
creating a non-fungible token (NFT) associated with the tracked gaming asset based on the received meta-data, wherein
the NFT is created based on a storage of the received meta-data to a distributed ledger associated with the first gaming application, and
the distributed ledger is shared across a set of gaming applications including the first gaming application;
receiving second information associated with a second game save state of a second gaming application of the set of gaming applications;
retrieving the created NFT associated with the gaming asset from the distributed ledger; and
initiating a restoration of the gaming asset for the player in the second gaming application, based on the received second information and the retrieved NFT associated with the gaming asset.

16. The non-transitory computer-readable medium according to claim 15, wherein the first gaming application is different from the second gaming application.

17. The non-transitory computer-readable medium according to claim 15, wherein the first gaming application is same as the second gaming application.

18. The non-transitory computer-readable medium according to claim 15, further comprising:
dis-associating the gaming asset from the first game save state of the first gaming application; and
associating the gaming asset with the second game save state of the second gaming application.

19. The non-transitory computer-readable medium according to claim 18, wherein
the gaming asset is unequipped for the player in the first gaming application, based on the dis-association of the gaming asset from the first game save state, and
the gaming asset is equipped for the player in the second gaming application, based on the association of the gaming asset with the second game save state.

20. The non-transitory computer-readable medium according to claim 15, wherein the first game save state corresponds to at least one of a level of the first gaming application, a mode of the first gaming application, an environment of the first gaming application, or a type of the player in the first gaming application.
